(19) United States
(12) Patent Application Publication
(10) Pub. No.: US 2026/0278490 A1
(43) Pub. Date: Sep. 17, 2026

(54) BUSINESS SUPPORT DEVICE, BUSINESS SUPPORT METHOD, AND RECORDING MEDIUM

(71) Applicant: NEC Corporation, Tokyo (JP)

(72) Inventors: Shin NORIEDA, Tokyo (JP); Hisaya WAKAYAMA, Tokyo (JP); Tsuyoshi NAKAMURA, Tokyo (JP); Tadaharu TAKAHASHI, Tokyo (JP); Keisuke KANEYASU, Tokyo (JP)

(73) Assignee: NEC Corporation, Tokyo (JP)

(21) Appl. No.: 19/558,771

(22) Filed: Mar. 6, 2026

(30) Foreign Application Priority Data
Mar. 17, 2025 (JP) 2025-042491

(51) Int. Cl. G06Q 10/0631

(52) U.S. Cl. CPC G06Q 10/0631

(57) ABSTRACT

In order to provide a business support device capable of accumulating and reusing assets acquired in business, the processor of the business support device acquires input information regarding a first business a user is considering. The processor extracts an element of the first business from the input information. The processor creates a fly wheel representing the first business, by connecting a plurality of extracted elements through a causal relationship.

### INCORPORATION BY REFERENCE

This application is based upon and claims the benefit of priority from Japanese Patent Application 2025-042491, filed on Mar. 17, 2025, the disclosure of which is incorporated herein in its entirety by reference.

### TECHNICAL FIELD

The present disclosure relates to a technique for utilizing assets acquired in business.

### BACKGROUND ART

In business development, it is desirable to accumulate and reuse assets acquired in existing business, such as customers and know-how. JP 2007-213564 A describes an information processing device that utilizes right resources such as information related to business in a right place.

Patent Document 1: Japanese Patent Application Laid-Open under No. 2007-213564

### SUMMARY

However, conventionally, business development has a problem that assets acquired in existing business are insufficiently accumulated, and business cannot be quickly launched.

An object of the present disclosure is to provide a business support device capable of accumulating and reusing assets acquired in business.

According to an example aspect of the present invention, there is provided a business support device including:

at least one memory configured to store instructions; and

at least one processor configured to execute the instructions to:

acquire input information regarding a first business a user is considering;

extract an element of the first business from the input information; and

create a fly wheel representing the first business, by connecting a plurality of extracted elements through a causal relationship.

According to another example aspect of the present invention, there is provided a business support method executed by a business support device, including:

acquiring input information regarding a business a user is considering;

extracting an element of the business from the input information; and

creating a fly wheel representing the business, by connecting a plurality of extracted elements through a causal relationship.

According to still another example aspect of the present invention, there is provided a non-transitory computer-readable recording medium storing a computer, the program causing the computer to execute processing of:

acquiring input information regarding a business a user is considering;

extracting an element of the business from the input information; and

creating a fly wheel representing the business, by connecting a plurality of extracted elements through a causal relationship.

### EFFECT

According to the present disclosure, it is possible to provide a business support device capable of accumulating and reusing assets acquired in business.

### BRIEF DESCRIPTION OF THE DRAWINGS

FIG. 1 illustrates an example of a schematic configuration of a business support system according to the present disclosure;

FIG. 2 is an example of fly wheels of a plurality of business plans;

FIGS. 3A and 3B are block diagrams illustrating examples of hardware configurations of a server and a user terminal;

FIG. 4 is a block diagram illustrating an example of a functional configuration of the server;

FIG. 5 is an example of a business support screen;

FIG. 6 is an example of fly wheels;

FIG. 7 is a flowchart illustrating a fly wheel creation procedure;

FIGS. 8A and 8B illustrate examples of patterns;

FIG. 9 is an example of a description format of an element;

FIG. 10 is an example of a fly wheel representing a business plan for a real estate matching system;

FIG. 11 is an example of a business support screen displaying fly wheels;

FIG. 12 is an example of inter-element association data;

FIG. 13 is a flowchart illustrating a procedure for synergy combination between businesses;

FIGS. 14A and 14B are diagrams for illustrating a method for determining the presence or absence of synergy;

FIG. 15 is a diagram for illustrating synergy combination;

FIG. 16 is an example of a synergy proposal screen;

FIG. 17 is an example of a synergy proposal screen displaying related elements in a distinguishable state;

FIG. 18 is a flowchart illustrating an example of fly wheel creation processing by the server;

FIG. 19 is another flowchart illustrating the fly wheel creation procedure;

FIG. 20 is a diagram for illustrating other fly wheel creation;

FIG. 21 is a diagram for illustrating presentation of an element candidate plan;

FIG. 22 is a diagram for illustrating an auxiliary function of classifying sentence;

FIG. 23 is a diagram for illustrating an auxiliary function of automatically adding an element;

FIG. 24 illustrates an example in which there are causal relationships between elements;

FIG. 25 is a flowchart illustrating a procedure for proposing a synergy element candidate plan;

FIG. 26 is a diagram for illustrating proposal of the synergy element candidate plan;

FIG. 27 is a flowchart illustrating a procedure for generating the synergy element candidate plan;

FIG. 28 is a diagram for illustrating a procedure for generating a new pattern;

FIG. 29 is a block diagram illustrating a functional configuration of a business support device; and

FIG. 30 is a flowchart by the business support device.

### EXAMPLE EMBODIMENTS

Hereinafter, example embodiments of the present disclosure will be described with reference to the drawings.

### First Example Embodiment

### Overall Configuration

A business support system of the present disclosure can improve the number of new business developments and efficiency thereof by constructing a multi-sided platform (Hereinafter, it is also referred to as “MSP”.) type business development ecosystem capable of accumulating and reusing acquired assets of business.

The purpose of the MSP strategy in business development is to make one business plan including startup cooperation and existing business cooperation successful, thereby increasing the success probability of other business plans or the entire project including a plurality of businesses. In other words, the purpose of the MSP strategy is to allow business development activity results and assets to contribute to improving the success probability of other business plans and projects.

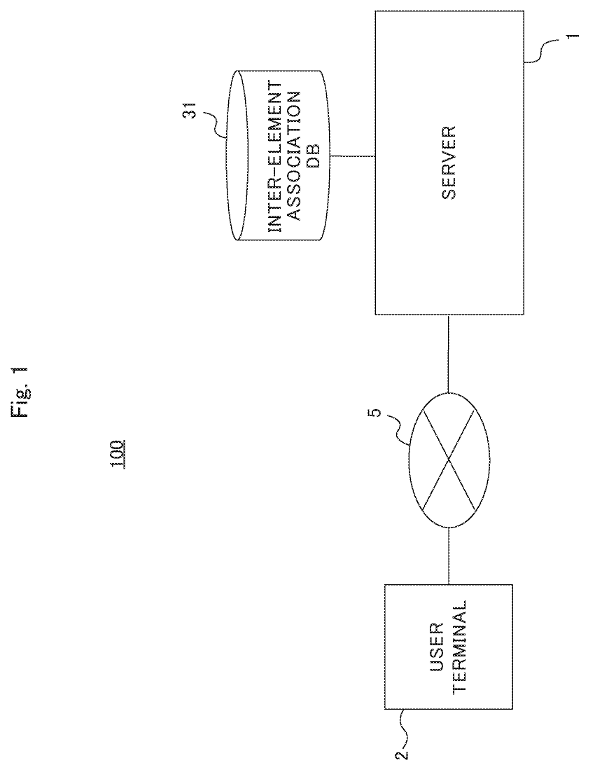

FIG. 1 is an example of a schematic configuration of a business support system 100 to which a business support device of the present disclosure is applied. The business support system 100 is a system in which a server 1 and a user terminal 2 are communicably connected via a network 5 such as the Internet, and a fly wheel representing a business plan is generated based on input information by a user. The business support system 100 is a system that proposes a new business plan that expands and accelerates by synergy (synergistic effect) between a plurality of businesses. In other words, the business support system 100 is a system that proposes to the user how to cooperate in order to generate synergy of the plurality of businesses in business development.

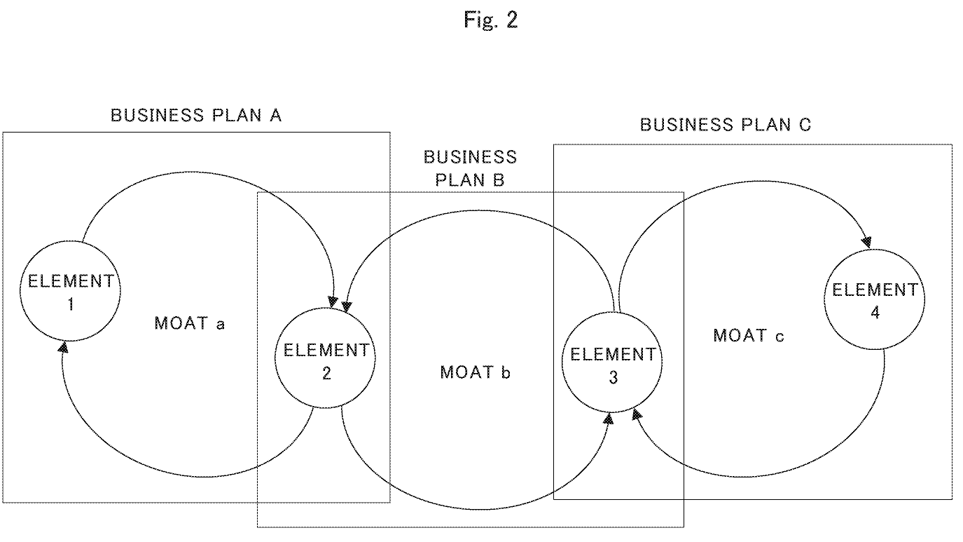

FIG. 2 is an example of fly wheels of a plurality of business plans. As illustrated in FIG. 2, a business plan A is a fly wheel having an element 1 and an element 2 as constituent elements, and has a moat a drawn at the center. A business plan B is a fly wheel having the element 2 and an element 3 as constituent elements, and has a moat b drawn at the center. A business plan C is a fly wheel having the element 3 and an element 4 as constituent elements, and has a moat c drawn at the center.

Here, the “moat” is a “moat” that keeps a business in a case where a castle that is the business is attacked by an external enemy (competitor), that is, a competitive advantage or an advantage of a company. In a case where a long-lasting business is created, it is essential to have a moat. The fly wheel is created by connecting specific elements with arrows in such a way as to form a loop, and is a model for continuously maintaining and accelerating business growth.

As illustrated in FIG. 2, the fly wheel of the business plan B is in a state of being rotated by the element 2 of the fly wheel of the business plan A, and the element 3 provided from the business plan B is generated as the fly wheel of the business plan B rotates. In addition, the fly wheel of the business plan C is in a state of being rotated by the element 3 of the fly wheel of the business plan B. The synergy in the present disclosure is to create a state in which fly wheels are connected by an element that a certain business can provide to another business, and mutual businesses get into a complementary relationship.

In the business support system 100 of FIG. 1, the server 1 is an information processing device that processes, stores, and transmits/receives various pieces of data, and is connected to an inter-element association database (Hereinafter, a “database” is referred to as a “DB”.) 31. The server 1 receives information input by the user from the user terminal 2 and transmits drawing data of a created fly wheel to the user terminal 2. The server 1 may be a virtual server present in a cloud environment. The server 1 is an example of the business support device of the present disclosure.

The user terminal 2 is a PC, a tablet, or the like used by the user, and transmits the information input by the user to the server 1 or receives the drawing data of the fly wheel from the server 1.

### Hardware configuration

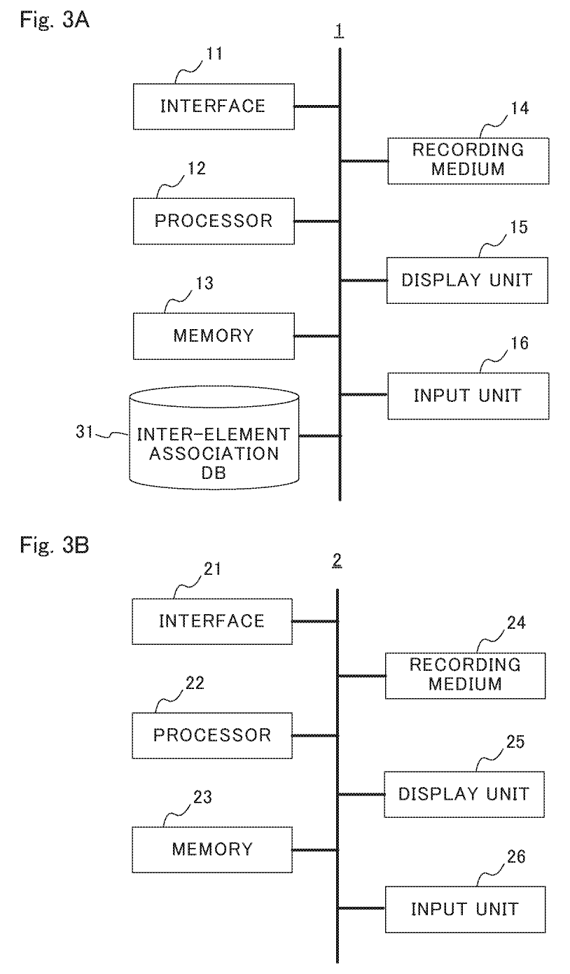

FIG. 3A is a block diagram illustrating an example of a hardware configuration of the server 1. As illustrated in the drawing, the server 1 includes an interface 11, a processor 12, a memory 13, a recording medium 14, a display unit 15, and an input unit 16. These components and the inter-element association DB 31 are connected to each other via a bus.

The interface 11 exchanges data with the user terminal 2. The interface 11 is used to receive input information from the user terminal 2 or to transmit a fly wheel to the user terminal 2.

The processor 12 is a computer such as a central processing unit (CPU), and controls the entire server 1 by executing a program prepared in advance. As the processor 12, a CPU, a graphics processing unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of these, or the like can be used.

The memory 13 includes a read only memory (ROM) and a random access memory (RAM). The memory 13 stores a program to be executed by the processor 12. The memory 13 is also used as a work memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In a case where the server 1 executes fly wheel creation processing, the program recorded in the recording medium 14 is loaded into the memory 13 and executed by the processor 12.

The display unit 15 displays a predetermined image by, for instance, a liquid crystal display (LCD). The input unit 16 is a keyboard, a mouse, a touch panel, or the like, and is used by an operator who manages the server 1.

Although details will be described later, the inter-element association DB 31 stores inter-element association data indicating association between elements constituting the business plan.

FIG. 3B is a block diagram illustrating an example of a hardware configuration of the user terminal 2. As illustrated in the drawing, the user terminal 2 includes an interface 21, a processor 22, a memory 23, a recording medium 24, a display unit 25, and an input unit 26.

The interface 21 exchanges data with the server 1 via the network 5. The interface 21 is used to transmit the information input by the user to the server 1, and to receive the drawing data of the fly wheel from the server 1.

The processor 22 is a computer such as a CPU, and controls an entire user terminal by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM, a RAM, and the like. The memory 23 stores a program to be executed by the processor 22. The memory 23 is also used as a work memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 is, for instance, an LCD and the like, and displays a predetermined image. The input unit 26 is a touch panel and the like, and is used in a case where the user performs a predetermined operation.

### Functional Configuration

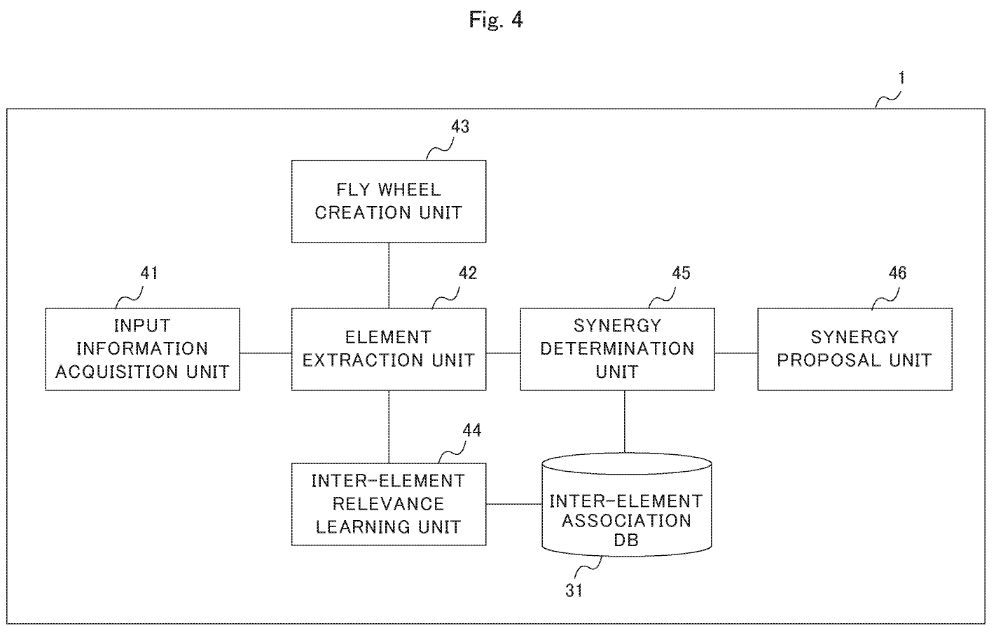

FIG. 4 is a block diagram illustrating an example of a functional configuration of the server 1. The server 1 functionally includes an input information acquisition unit 41, an element extraction unit 42, a fly wheel creation unit 43, an inter-element relevance learning unit 44, a synergy determination unit 45, and a synergy proposal unit 46.

The input information acquisition unit 41, the element extraction unit 42, the fly wheel creation unit 43, the inter-element relevance learning unit 44, the synergy determination unit 45, and the synergy proposal unit 46 are implemented by the processor 12 executing a program.

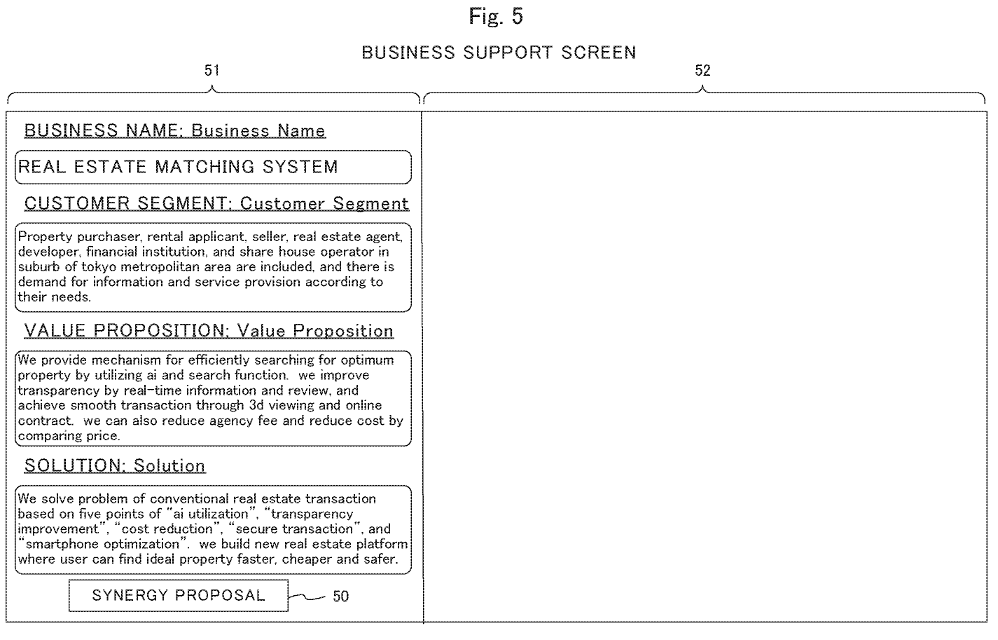

The input information acquisition unit 41 acquires information regarding a business plan input by the user from the user terminal 2 as input information. FIG. 5 is an example of a business support screen displayed on the user terminal 2. The business support screen includes an input area 51 to which the input information regarding the business plan is input by the user, an output area 52 for outputting a fly wheel created based on the input information, and a synergy proposal button 50. As illustrated in FIG. 5, in the input area 51, the user inputs a business outline such as a business name (Business Name) of a business being considered, a customer segment (Customer Segment), value proposition (Value Proposition), and a solution (Solution).

The element extraction unit 42 extracts elements constituting the business plan from the input information. The elements are key points that accelerate business growth. By the element extraction unit 42, it is possible to extract what kind of element can accelerate the business the user is considering and can build the moat.

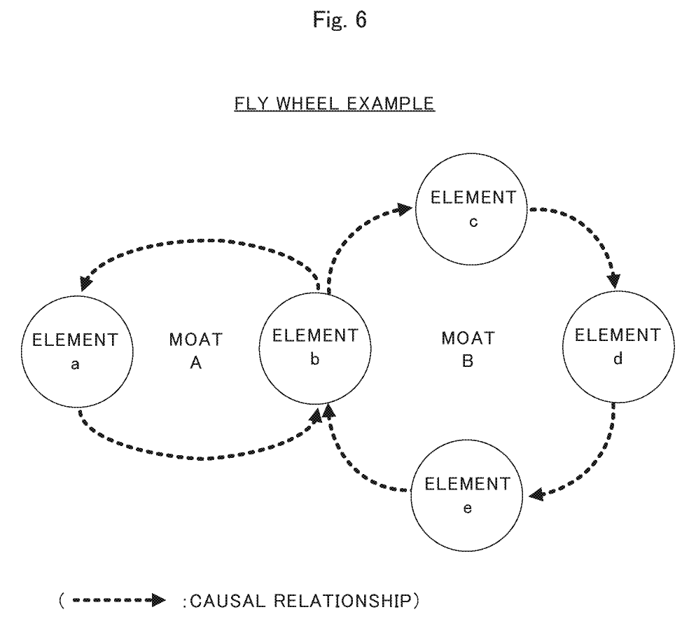

The fly wheel creation unit 43 creates and outputs a fly wheel based on the elements extracted by the element extraction unit 42. Specifically, the fly wheel creation unit 43 creates a fly wheel representing a predetermined business plan or an existing business (Hereinafter, they are also collectively referred to as a “business plan”.) by connecting elements with arrows in such a way as to form a loop. FIG. 6 is an example of fly wheels. In the example of FIG. 6, elements a and b and elements b to e are connected by arrows in such a way as to form loops, thereby creating the fly wheels. A moat A and a moat B are drawn at the center of each loop. The fly wheel may have a plurality of loops in one business plan, or may be one loop. In addition, the fly wheel creation unit 43 may create a fly wheel in consideration of not only the elements extracted by the element extraction unit 42 but also the input information.

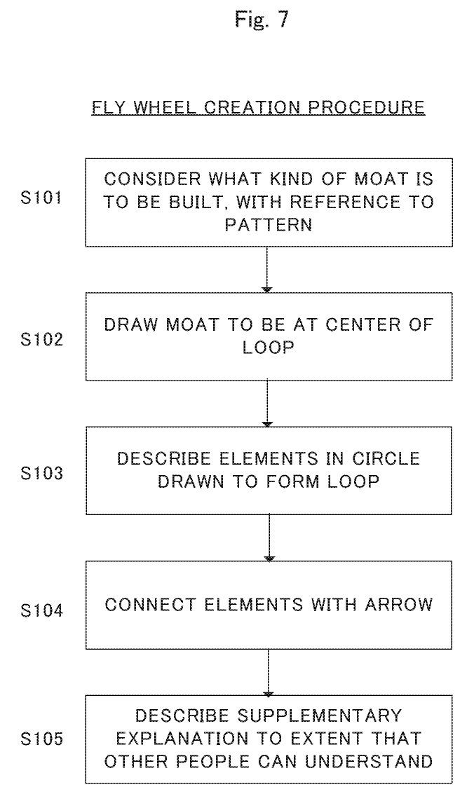

FIG. 7 is a flowchart illustrating a fly wheel creation procedure. With reference to a pattern, the fly wheel creation unit 43 considers what kind of moat is to be built, based on the elements extracted by the element extraction unit 42 and the input information (step S101). Here, the pattern is a framework for creating a fly wheel based on a flow of successful cases and general business models.

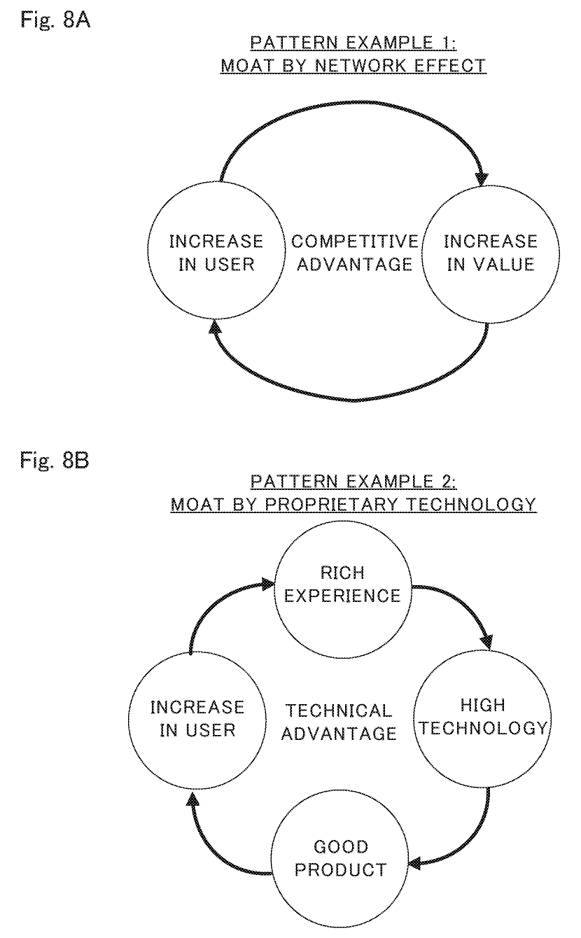

FIGS. 8A and 8B illustrate examples of patterns. FIG. 8A is a loop in which an element “increase in user” and an element “increase in value” are connected by arrows, and is a pattern of a moat by a network effect. This pattern builds the moat that increases the value as the number of users increases and enhances competitive advantage. FIG. 8B is a loop in which an element “rich experience”, an element “high technology”, an element “good product”, and an element “increase in user” are connected by arrows, and is a pattern of a moat by proprietary technology. This pattern builds a moat that increases market share by having a technical advantage that others cannot easily imitate.

The fly wheel creation unit 43 acquires various patterns, and considers what kind of moat is to be built, based on the elements extracted by the element extraction unit 42 and the input information. Specifically, the fly wheel creation unit 43 acquires a pattern stored in advance in a DB or the server 1, and considers what kind of moat is to be built.

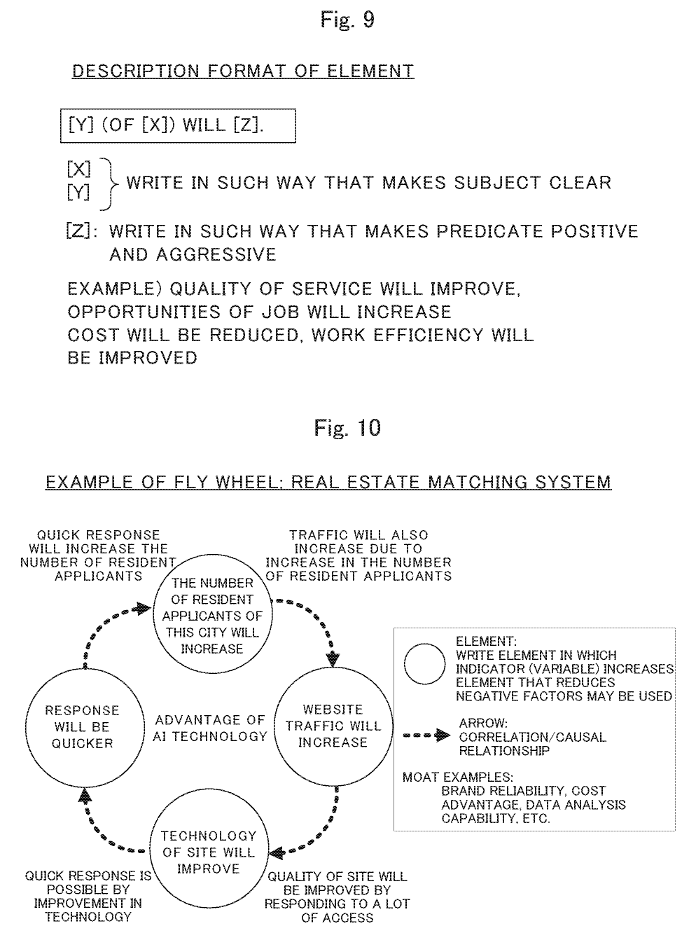

In a case where determining what kind of moat is to be built, the fly wheel creation unit 43 draws the moat to be at the center of the loop (step S102). Next, the fly wheel creation unit 43 describes the elements in a circle drawn to form the loop (step S103). At this time, the fly wheel creation unit 43 describes the elements extracted by the element extraction unit 42 in the format of “what will what”. FIG. 9 is an example of a description format of an element. As illustrated in FIG. 9, the element is desirably described in a format of “Y of X will Z” or “Y will Z” in such a way that “Y of X” or "Y” is a subject and “Z” is a predicate having a positive and aggressive connotation. Examples of description of the element include “quality of service will improve”, “opportunities of job will increase”, “cost will be reduced”, “work efficiency will be improved”, and the like.

The fly wheel creation unit 43 creates the fly wheel by connecting the elements with arrows in such a way as to form a loop (step S104), and describing a causal relationship indicated by the arrows as a supplementary explanation to the extent that other people can understand (step S105). The fly wheel creation unit 43 transmits the drawing data of the created fly wheel to the user terminal 2.

Note that the fly wheel creation unit 43 draws the moat to be at the center of the loop in the processing of step S102, but in a case where the fly wheel is created as a drawing tool of graph theory, drawing may be started from the processing of step S103, and as a result, the order of drawing is optional as long as the same fly wheel is obtained.

FIG. 10 is an example of a fly wheel representing a business plan for a real estate matching system. Specifically, with reference to a pattern, in a case where the fly wheel creation unit 43 determines to build a moat that increases a market share by having an advantage by an artificial intelligence (AI) technology, for instance, as illustrated in FIG. 10, “advantage of AI technology” that is the moat is drawn to be at the center of the loop.

Next, as illustrated in FIG. 10, the fly wheel creation unit 43 describes the elements “the number of resident applicants of this city will increase”, “website traffic will increase”, “technology of site will improve”, and “response will be quicker” extracted by the element extraction unit 42 in the circle drawn to form the loop, according to the description format. The fly wheel creation unit 43 connects the elements with arrows in such a way as to form the loop, and for instance, “website traffic will also increase due to increase in the number of resident applicants” is described as a supplementary explanation of the arrow connecting the element “the number of resident applicants of this city will increase” and the element “website traffic will increase”. For convenience of description, the fly wheel representing the business plan for the real estate matching system is one loop as illustrated in FIG. 10, but the present disclosure is not limited thereto, and may be a plurality of loops.

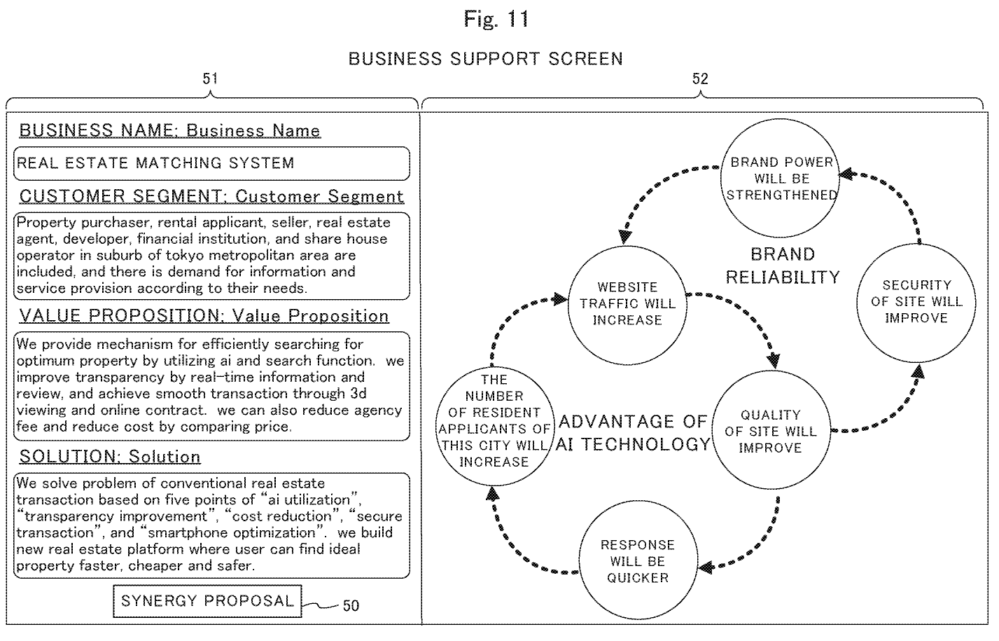

The fly wheel creation unit 43 transmits the drawing data of the created fly wheel to the user terminal 2. FIG. 11 is an example of a business support screen displayed on the user terminal 2. As illustrated in FIG. 11, the user terminal 2 displays fly wheels representing the business plan for the real estate matching system in the output area 52 of the business support screen based on the received drawing data of the fly wheel.

The inter-element relevance learning unit 44 stores the inter-element association data of the created fly wheel in the inter-element association DB 31. According to the inter-element relevance learning unit 44, the inter-element association DB 31 can be a DB that has learned a connection between elements for accelerating a business, that is, a connection between elements with past business development and an existing business. In addition, the inter-element relevance learning unit 44 generates a learned model holding the inter-element association data in a case where the server 1 performs processing using the generative AI. As an example of the generative AI, a large language model (LLM) may be exemplified.

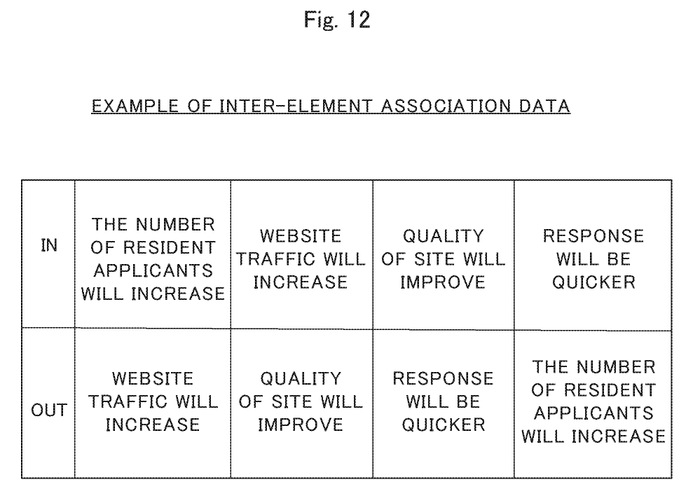

FIG. 12 is an example of the inter-element association data. The inter-element association data is data in which an IN element and an OUT element for each element are associated with each other. Here, the IN element is contents of an element that enters a predetermined element, and the OUT element is contents of an element that exits from the element. For instance, in the case of the fly wheel as illustrated in FIG. 10, the element “website traffic will increase” has the IN element “the number of resident applicants of this city will increase” and the OUT element “website traffic will increase”. The inter-element relevance learning unit 44 stores, in the inter-element association DB 31, the inter-element association data in which the IN element and the OUT element of each element constituting the created fly wheel are associated with each other.

The inter-element relevance learning unit 44 may, for instance, extract a feature amount indicating closeness between the elements by understanding the IN element and the OUT element by using the LLM, and store the extracted feature amount together as the inter-element association data. The inter-element association data may also hold information such as a business outline and a moat.

The inter-element association data stored in the inter-element association DB 31 is used as learning data at the time of next and subsequent fly wheel creation or synergy proposal to be described later. Although omitted for convenience of description, the element extraction unit 42 and the fly wheel creation unit 43 may use the inter-element association data as the learning data in a case of extracting the elements or creating the fly wheel.

In a case of receiving a synergy proposal request, the synergy determination unit 45 determines whether there is an existing business getting into a complementary relationship with a target business plan due to synergy. The synergy proposal unit 46 proposes another business having high synergy with the target business plan, that is, the business plan the user is considering and elements of the another business. Here, the synergy proposal request is made by causing the user to select one element constituting the fly wheel representing the target business plan and press the synergy proposal button 50 on the business support screen. Note that the synergy proposal request is not limited thereto, and for instance, any method such as double-clicking the element constituting the target fly wheel on the business support screen can be applied.

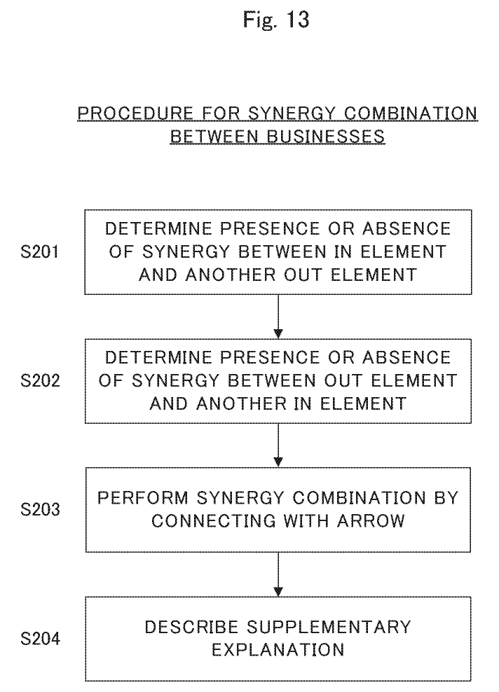

FIG. 13 is a flowchart illustrating a procedure for synergy combination between businesses. The synergy determination unit 45 refers to the inter-element association DB 31 and determines whether an OUT element of a fly wheel representing a business plan to be a target of the synergy proposal request (Hereinafter, it is also referred to as the “target business plan”.) becomes an IN element of a fly wheel representing an existing business. In other words, the synergy determination unit 45 determines the presence or absence of synergy between the IN element of the existing business and the OUT element of the target business plan (step S201).

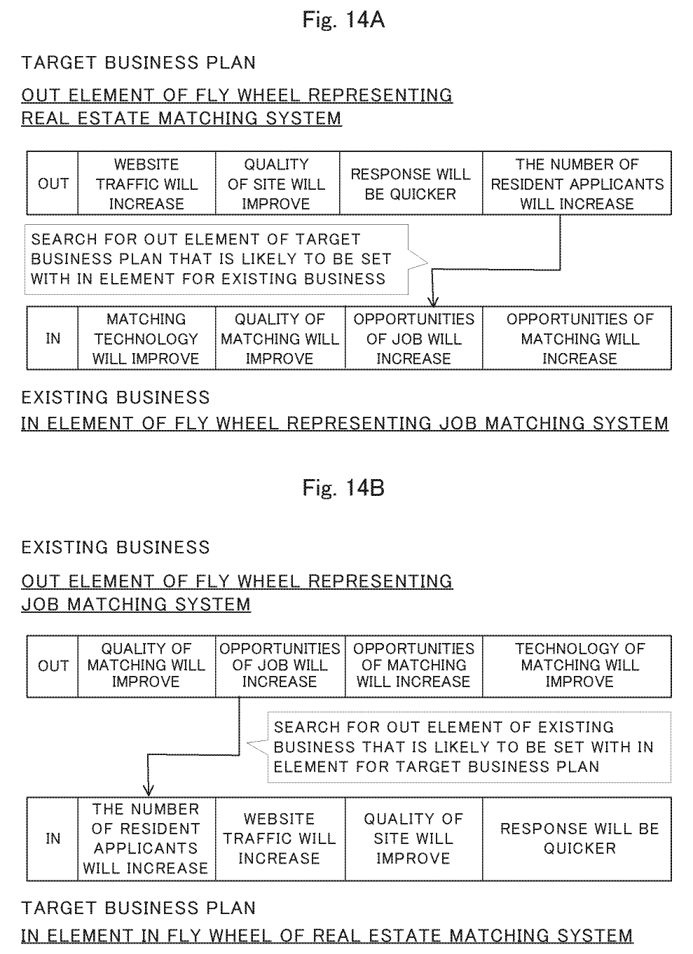

FIGS. 14A and 14B are diagrams for illustrating a method for determining the presence or absence of synergy between the IN element and the OUT element. FIG. 14A illustrates an example of each of an OUT element of a fly wheel representing a real estate matching system that is the target business plan and an IN element of a fly wheel representing a job matching system that is the existing business. The synergy determination unit 45 refers to the inter-element association DB 31 and searches for the OUT element of the target business plan that is likely to be a set with the IN element for the existing business, as illustrated in FIG. 14A. For instance, the synergy determination unit 45 determines that there is synergy in a combination of the OUT element “the number of resident applicants will increase” of the target business plan and the IN element “opportunities of job will increase” of the existing business.

In addition, the synergy determination unit 45 determines the presence or absence of synergy between the OUT element of the existing business and the IN element of the target business plan (step S202). FIG. 14B illustrates an example of each of an OUT element of the fly wheel representing the job matching system that is the existing business and an IN element of the fly wheel representing the real estate matching system that is the target business plan. The synergy determination unit 45 refers to the inter-element association DB 31 and searches for the OUT element of the existing business that is likely to be a set with the IN element for the target business plan, as illustrated in FIG. 14B. For instance, the synergy determination unit 45 determines that there is synergy in a combination of the OUT element “opportunities of job will increase” of the existing business and the IN element “the number of resident applicants will increase” of the target business plan.

In a case where it is difficult to consider the set of the IN element and the OUT element, the synergy determination unit 45 searches for the OUT element to be the set by considering what is necessary to increase the IN element. Specifically, in a case where the IN element is “the number of resident applicants will increase”, the OUT element is searched for in consideration of what elements are used to increase the number of people who wish to live in this city, for instance, “city is beautiful”, “access to workplace is good”, and the like. In addition, the synergy determination unit 45 may consider the set of the IN element and the OUT element in consideration of the pattern of the fly wheel. In addition, the synergy determination unit 45 may consider the set of the IN element and the OUT element by using the LLM.

The synergy proposal unit 46 performs synergy combination by connecting the IN element and the OUT element determined to have synergy with an arrow (step S203), and describes, as a supplementary explanation, a causal relationship indicated by the arrow to the extent that other people can understand (step S204). By repeating the processing of steps S201 to S204, the synergy proposal unit 46 creates a fly wheel in which the existing business is combined with the target business plan by synergy. The synergy proposal unit 46 transmits drawing data of the created fly wheel to the user terminal 2 as a synergy proposal. The fly wheel creation unit 43 may create the fly wheel in which the existing business is combined with the target business plan by synergy.

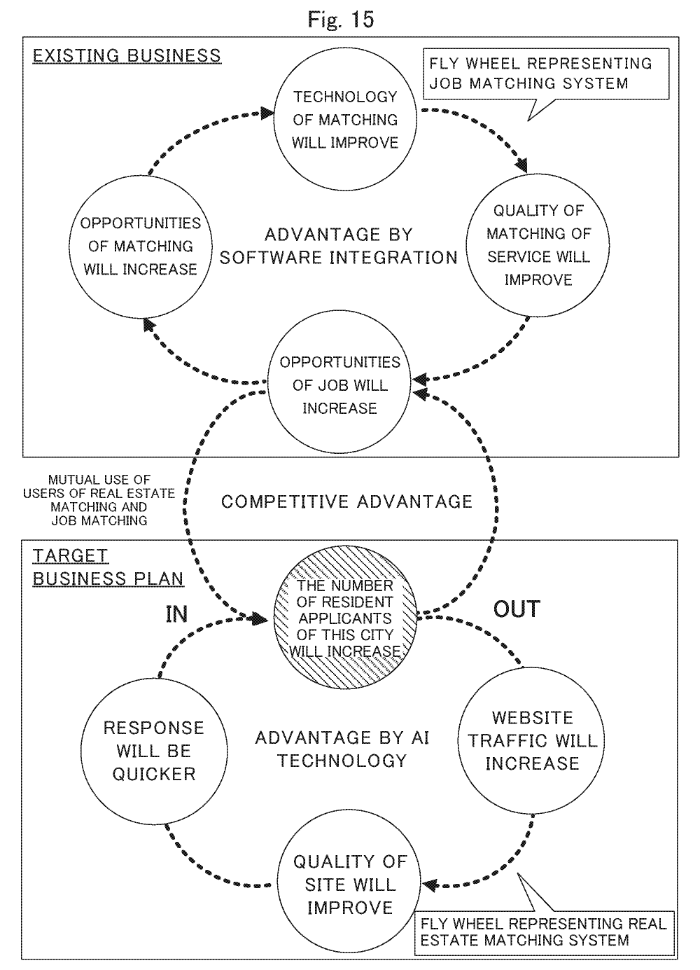

FIG. 15 is a diagram for illustrating synergy combination. In a case where the synergy proposal request is received, for instance, in a case where the synergy proposal button 50 is pressed on the business support screen, the synergy determination unit 45 determines that the OUT element “the number of resident applicants of this city will increase” of the fly wheel representing the real estate matching system that is the target business plan becomes the IN element “opportunities of job will increase” of the fly wheel representing the job matching system that is the existing business. In addition, the synergy determination unit 45 determines that the OUT element “opportunities of job will increase” of the fly wheel representing the job matching system that is the existing business becomes the IN element “the number of resident applicants of this city will increase” of the fly wheel representing the real estate matching system that is the target business plan.

Next, the synergy proposal unit 46 performs synergy combination by connecting with arrows the IN and OUT elements determined to have synergy, and describes that “mutual use of users of real estate matching and job matching” as a supplementary explanation of the arrow. As a result, the synergy proposal unit 46 creates the fly wheel as illustrated in FIG. 15 in which the real estate matching system as the target business plan and the job matching system as the existing business are combined by synergy.

For convenience of description, the fly wheel in which the two businesses are combined by synergy is configured by a total of three loops, that is, a loop in which a moat “advantage by AI technology” is built, a loop in which a moat “advantage by software integration” is built, and a loop in which a moat “competitive advantage” is built by synergy combination, as illustrated in FIG. 15. However, the present disclosure is not limited thereto, and the fly wheel in which the two businesses are combined by synergy may be configured by equal to or more than three loops, and the configuration thereof is optional.

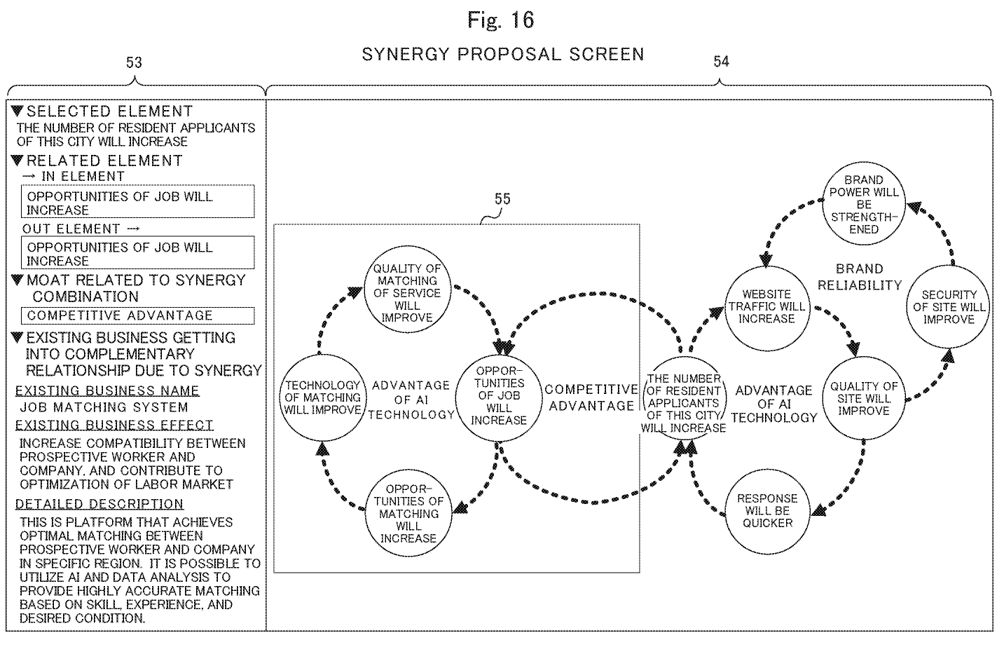

The synergy proposal unit 46 transmits drawing data of the created fly wheel to the user terminal 2 as a synergy proposal. FIG. 16 is an example of a synergy proposal screen displayed on the user terminal 2. The synergy proposal screen includes a sentence output area 53 for outputting the synergy proposal by sentences and a fly wheel output area 54 for outputting the synergy proposal by the fly wheel. As illustrated in FIG. 16, based on the received drawing data of the fly wheel, the synergy proposal unit 46 displays the fly wheel in which the real estate matching system as the target business plan and the job matching system as the existing business are combined by synergy in the fly wheel output area 54 of the synergy proposal screen. At this time, the existing business combined by synergy is desirably displayed in a state distinguishable from the target business plan, for instance, being surrounded by a line 55.

The synergy proposal unit 46 may perform not only the synergy proposal by the drawing of the fly wheel but also the synergy proposal by the sentences. As illustrated in FIG. 16, the synergy proposal by the sentences has the element “the number of resident applicants of this city will increase” selected by the user in a case where the synergy proposal button 50 is pressed, the IN element “opportunities of job will increase” and the OUT element “opportunities of job will increase” for the selected element, the moat “competitive advantage” related to the synergy combination, and information regarding the existing business getting into the complementary relationship due to synergy, and is displayed in the sentence output area 53 of the synergy proposal screen. In this manner, the synergy proposal unit 46 can perform the synergy proposal by one or more of the drawing of the fly wheel and the sentences.

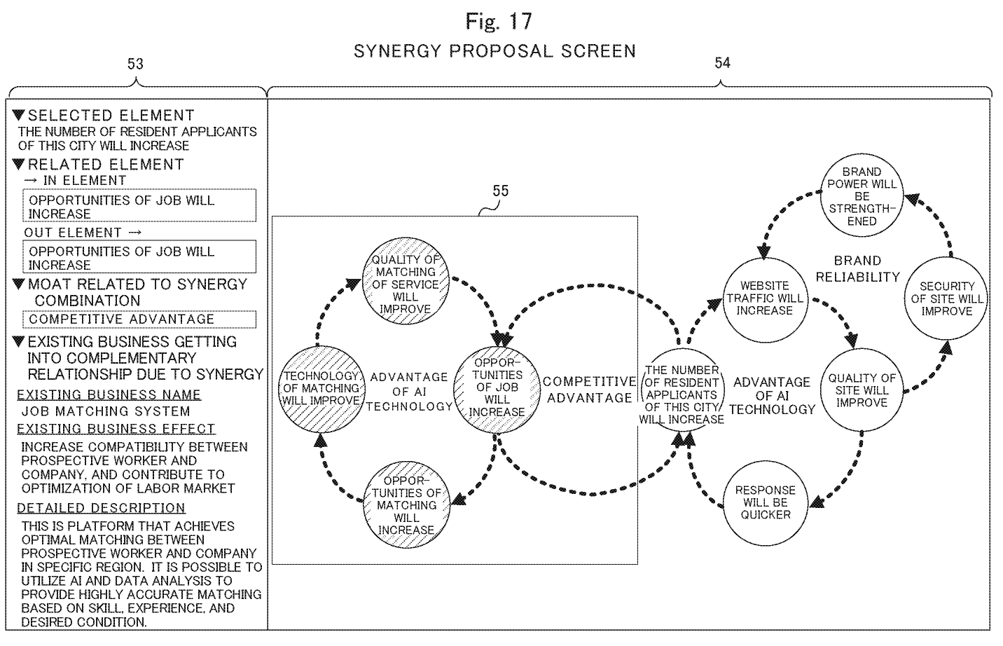

In addition, in the case where the synergy proposal unit 46 performs the synergy proposal by the drawing of the fly wheel, in a case where the user selects any moat on the synergy proposal screen, an element related to the moat may be displayed in a state distinguishable from other elements. FIG. 17 is an example of the synergy proposal screen displaying elements related to the selected moat in the distinguishable state. For instance, in a case where the user selects the moat “advantage of AI technology” by double clicking or the like, the elements of the loop building the moat are displayed in a different color as illustrated in FIG. 17. That is, the elements related to the selected moat are displayed in the state distinguishable from other elements. Similarly to the synergy proposal screen, in a case where the user selects any moat on the business support screen, elements related to the moat may be displayed in the state distinguishable from other elements.

Not only in the case where the user selects any moat, but also in a case where any loop is selected by a predetermined operation, elements of the loop may be displayed in a different color. In a case where the elements related to the selected moat or loop are in the state distinguishable from other elements, any method such as changing the color of the elements, changing the color of arrows, or highlighting can be applied.

In the above configuration, the input information acquisition unit 41, the element extraction unit 42, the fly wheel creation unit 43, the inter-element relevance learning unit 44, the synergy determination unit 45, and the synergy proposal unit 46 of the server 1 are examples of an input information acquisition means, an element extraction means, a fly wheel creation means, an inter-element relevance holding means, a determination means, and a proposal means of the present disclosure, respectively.

### Fly Wheel Creation Processing

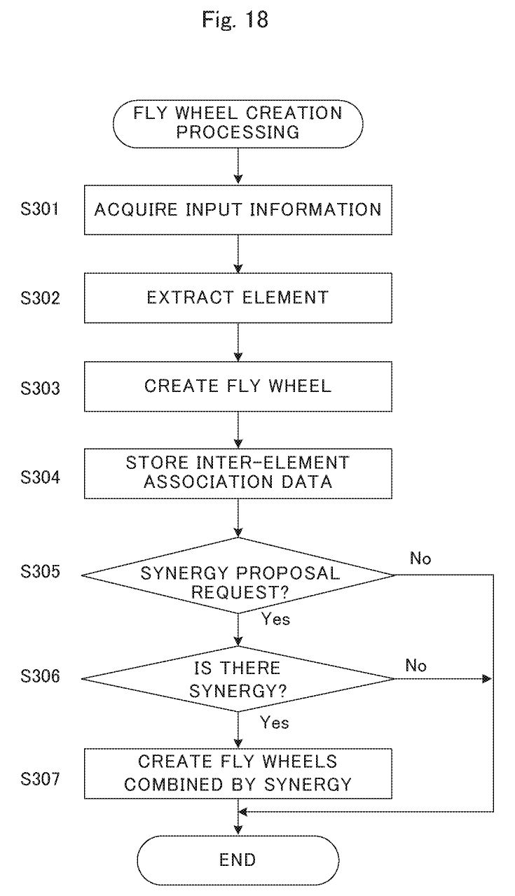

Next, fly wheel creation processing by the server 1 will be described. FIG. 18 is a flowchart illustrating an example of the fly wheel creation processing by the server 1. This processing is implemented by the processor 12 illustrated in FIG. 3A executing a program prepared in advance.

First, the server 1 acquires information regarding a business plan input by the user from the user terminal 2 as input information (step S301), and extracts elements constituting the business plan from the input information (step S302). Next, the server 1 creates a fly wheel based on the extracted elements and the input information, and transmits drawing data of the fly wheel to the user terminal 2 (step S303). By displaying the fly wheel based on the drawing data received by the user terminal 2, the user can easily confirm the fly wheel representing the business plan optionally input by the user himself/herself. The server 1 stores the inter-element association data of the created fly wheel in the inter-element association DB 31 (step S304).

Next, the server 1 determines whether a synergy proposal request has been received (step S305). If the synergy proposal request has not been received (step S305; No), the server 1 ends the fly wheel creation processing. On the other hand, if the synergy proposal request has been received (step S305; Yes), the server 1 determines whether there is an existing business getting into a complementary relationship with the business plan of the target fly wheel due to synergy (step S306). If there is no existing business getting into the complementary relationship due to synergy (step S306; No), the server 1 ends the fly wheel creation processing.

On the other hand, if there is the existing business getting into the complementary relationship due to synergy (step S306; Yes), the server 1 creates a fly wheel in which the target business plan and the existing business are combined by synergy, by connecting with arrows an IN element and an OUT element determined to have synergy (step S307). The server 1 transmits drawing data of the created fly wheel to the user terminal 2 as a synergy proposal. By displaying the fly wheel based on the drawing data received by the user terminal 2, the user can easily confirm the existing business having the complementary relationship due to synergy. Thus, the fly wheel creation processing ends.

According to the business support system 100, assets acquired in business, such as customers and know-how, can be accumulated in the inter-element association DB 31 and the like and reused. Specifically, the business support system 100 refers to the inter-element association DB 31, and can present a fly wheel representing the business being considered to the user. Furthermore, the business support system 100 can refer to the inter-element association DB 31 and propose, to the user, another business getting into a complementary relationship due to synergy with the business being considered.

In this manner, the business support system 100 can propose how to cooperate in order to generate synergy between a plurality of businesses in business development. Specifically, according to the business support system 100, it is possible to extract what kind of element can accelerate the business the user is considering, including startup cooperation and existing business cooperation, and can build a moat. In addition, according to the business support system 100, it is possible to accumulate a connection between elements for accelerating business as a DB in which a connection between elements of past business development and an existing business is learned. In addition, according to the business support system 100, it is possible to propose another business having high synergy with the business the user is considering and an element of the another business by the element extraction function and the DB.

### First Modification Example

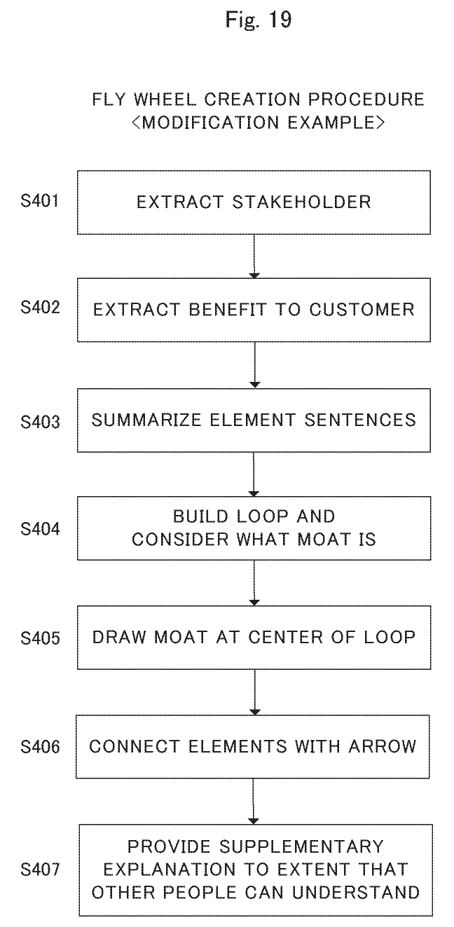

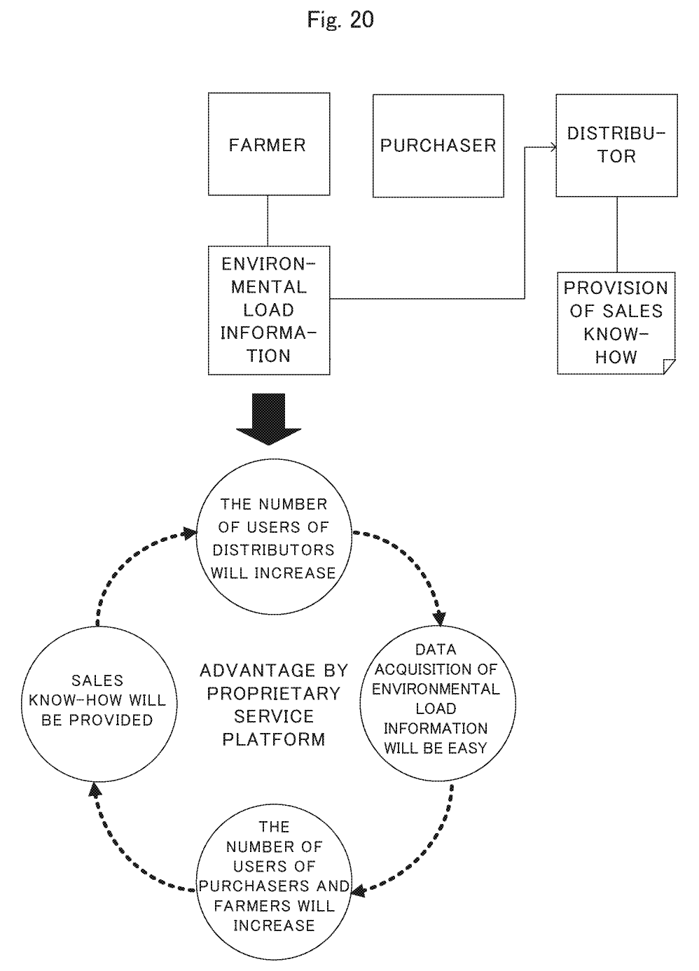

A modification example of the fly wheel creation procedure will be described. FIG. 19 is a flowchart illustrating the fly wheel creation procedure according to the modification example. FIG. 20 is a diagram for illustrating fly wheel creation according to the modification example. The fly wheel creation unit 43 of the server 1 first extracts stakeholders from input information (step S401). Here, the stakeholders are interested parties that influence business. For instance, in a case where the input information is a business outline regarding sales of organic vegetables, the fly wheel creation unit 43 extracts a farmer, a purchaser, and a distributor as the stakeholders from a customer segment of the input information, as illustrated in FIG. 20.

Next, the fly wheel creation unit 43 extracts benefits to the stakeholders from the input information (step S402). For instance, the fly wheel creation unit 43 extracts benefits that environmental load information can be acquired, sales know-how is provided, and the like from value proposition of the input information. The fly wheel creation unit 43 refers to the inter-element association DB 31 and summarizes element sentences in the format of “what will what” based on the extracted stakeholders and benefits (step S403).

The fly wheel creation unit 43 builds a loop by a circle describing the element sentence, and considers what a moat is (step S404). For instance, as illustrated in FIG. 20, the fly wheel creation unit 43 creates a loop by an element “the number of users of purchasers and farmers will increase”, an element “data acquisition of environmental load information will be easy”, an element “the number of users of distributors will increase”, and an element “sales know-how will be provided”, and considers what a moat is.

In a case of determining what kind of moat is to be built, the fly wheel creation unit 43 draws the moat at the center of the loop (step S405). For instance, as illustrated in FIG. 20, the fly wheel creation unit 43 draws a moat “advantage by proprietary service platform” at the center of the loop. The fly wheel creation unit 43 creates a fly wheel by connecting the elements with arrows (step S406), and describing a causal relationship indicated by the arrows as a supplementary explanation to the extent that other people can understand (step S407).

The fly wheel creation unit 43 may summarize element sentences by using the LLM or determine what a moat is.

According to the modification example of such a fly wheel creation procedure, it is possible to create the fly wheel that builds any moat without being limited to a pattern.

### Second Modification Example

The user may freely edit the fly wheel displayed on the business support screen or the synergy proposal screen, by a predetermined operation. Specifically, the user can change or delete an element constituting the fly wheel, add a new element, or the like.

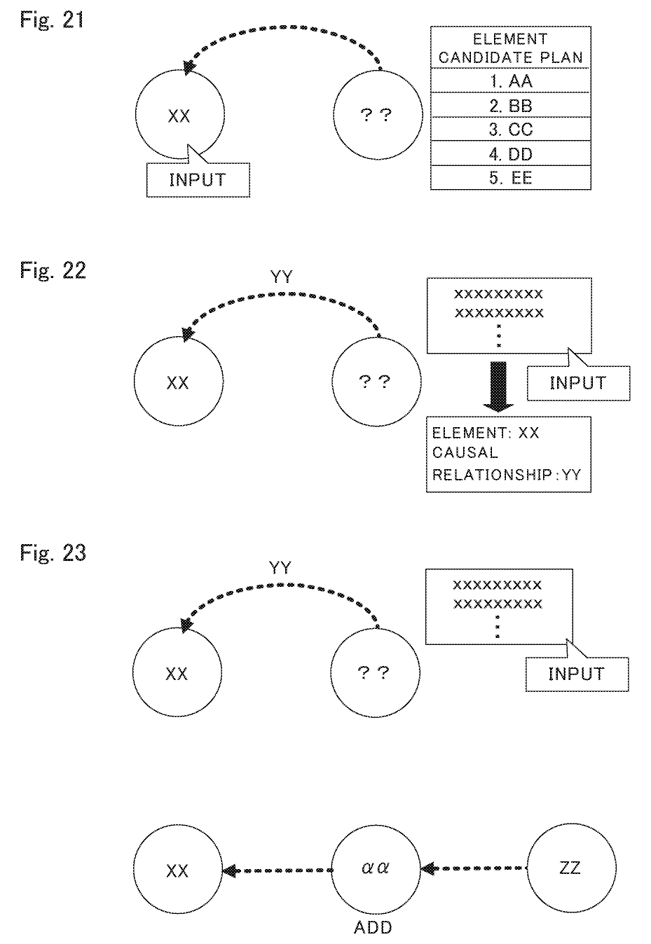

FIG. 21 is a diagram for illustrating presentation of an element candidate plan. For instance, in a case where the user adds a new element, the server 1 refers to the inter-element association DB 31 and examines an IN element and an OUT element, thereby presenting an element having a high possibility of having a causal relationship with the new element as an element candidate plan as illustrated in FIG. 21. According to this, in the case where the element of the fly wheel is changed or the new element is added by the user, the server 1 can present an element candidate plan of another business that can generate synergy. The fly wheel creation unit 43 of the server 1 may create the fly wheel based on the element candidate plan.

FIG. 22 is a diagram for illustrating an auxiliary function of classifying a sentence. For instance, in a case where the user inputs any sentence, the server 1 refers to the inter-element association DB 31 and classifies the sentence into an element and a causal relationship and presents them as illustrated in FIG. 22.

FIG. 23 is a diagram for illustrating an auxiliary function of automatically adding an element. For instance, in the case where the user inputs any sentence, the server 1 refers to the inter-element association DB 31 and classifies the sentence into the element and the causal relationship. At this time, if the sentence is constituted by a plurality of causal relationships, the server 1 newly adds an element “αα”, and connects an element “ZZ” to the element “αα” and the element “αα” to an element “XX” with arrows, as illustrated in FIG. 23.

### Third Modification Example

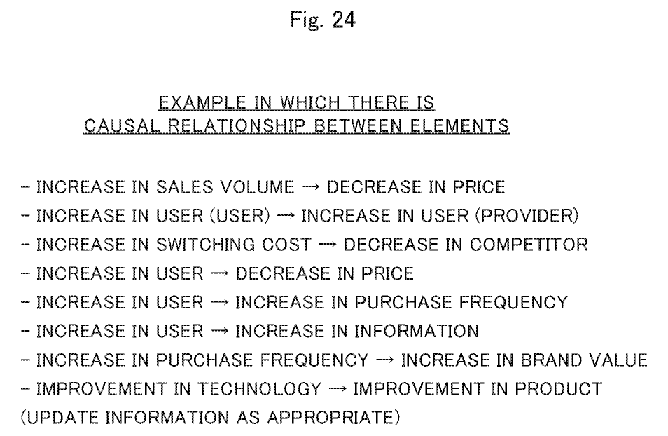

The server 1 may store a typical example in which there is a causal relationship between elements in the inter-element association DB 31 in advance, and consider the typical example in a case of proposing an element candidate plan. FIG. 24 illustrates an example in which there are causal relationships between elements. As illustrated in FIG. 24, an element “increase in user (user)” and an element “increase in user (provider)”, an element “increase in element” and an element “decrease in price”, an element “increase in switching cost” and an element “decrease in competitor”, and the like are given. Information of the typical example stored in the inter-element association DB 31 is desirably updated as appropriate.

### Fourth Modification Example

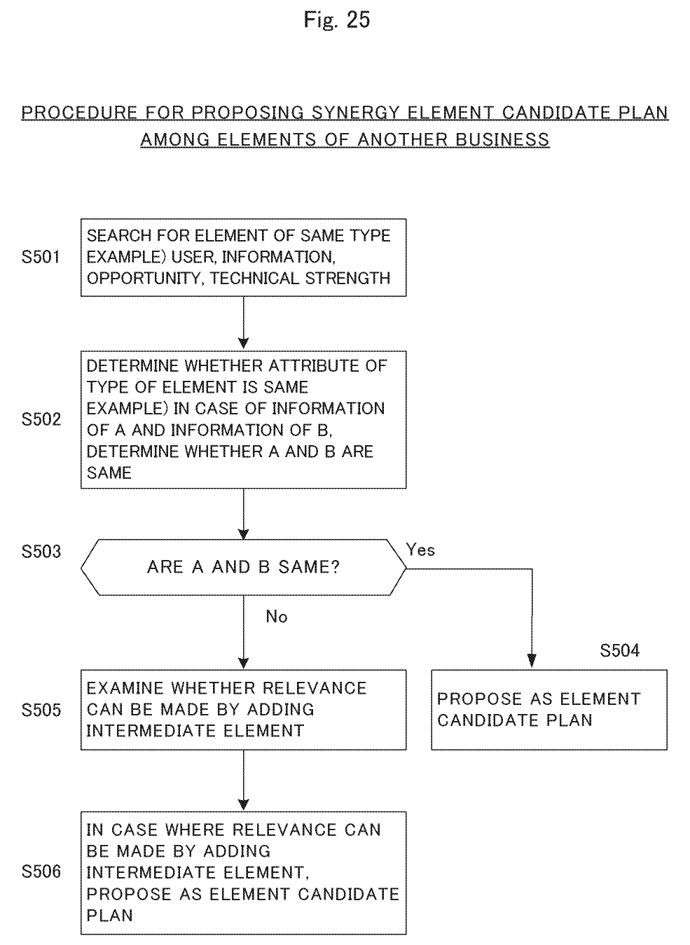

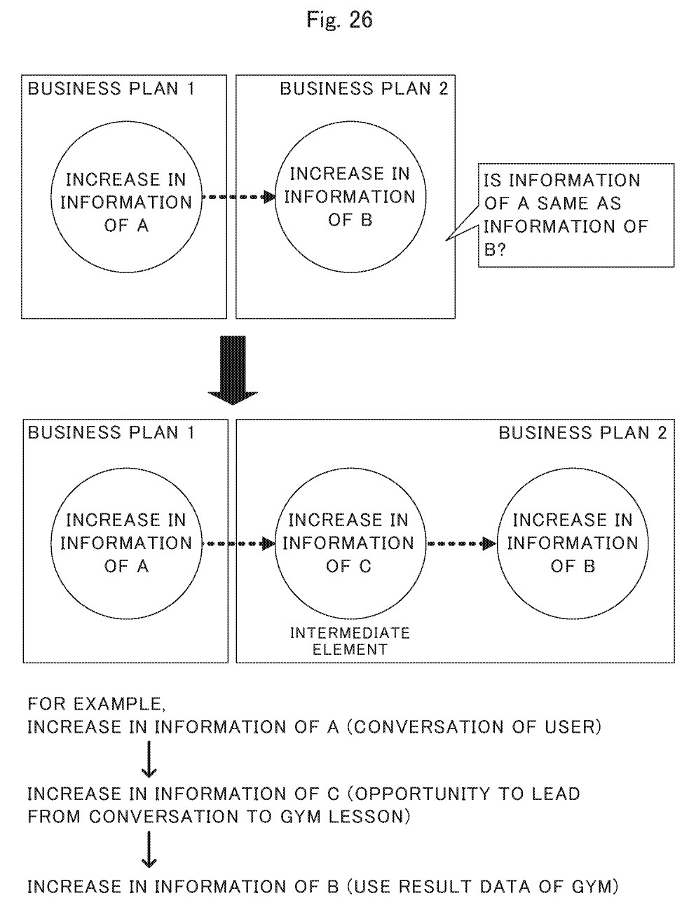

FIG. 25 is a flowchart illustrating a procedure for proposing an element candidate plan having a high inter-element relationship among elements of another business. The element candidate having the high inter-element relationship is also referred to as a “synergy element candidate”. FIG. 26 is a diagram for illustrating proposal of the synergy element candidate plan. First, the server 1 searches for elements of the same type (step S501). The fact that the types of elements are the same means that, for instance, users, information, opportunities, technical strengths, and the like are the same.

Next, the server 1 determines whether attributes of the types of the elements are the same (step S502). For instance, as illustrated in FIG. 26, in a case of an element “increase in information of A” in Business Plan 1 and an element “increase in information of B” in Business Plan 2, since the type that is information is the same, it is determined whether the attributes A and B are the same.

If it is determined that the attributes are the same (step S503; Yes), the server 1 proposes the element having the same attribute as the element candidate plan (step S504). On the other hand, if the attributes are not the same (step S503; No), the server 1 refers to the inter-element association DB 31 and examines whether relevance can be made by adding an intermediate element (step S505). In a case where the relevance can be made by adding the intermediate element, the server 1 proposes the intermediate element and the element with which the relevance is made as the element candidate plan (step S506).

For instance, as illustrated in FIG. 26, in a case where the element “increase in information of A” is “increase in conversation of user” and the element “increase in information of B” is “increase in use result data of gym”, the attributes of A and B are “conversation of user” and “use result data of gym”, respectively, and are not the same. Therefore, the server 1 considers adding an intermediate element “increase in information of C (opportunity to lead from conversation to gym lesson)”. If it is determined that the relevance can be made by adding the intermediate element, the server 1 proposes the intermediate element “increase in information of C” and the element “increase in information of B” with which the relevance can be made as the element candidate plan.

The server 1 may estimate the relevance between the elements by using the LLM based on the inter-element association DB 31 and the input information.

### Fifth Modification Example

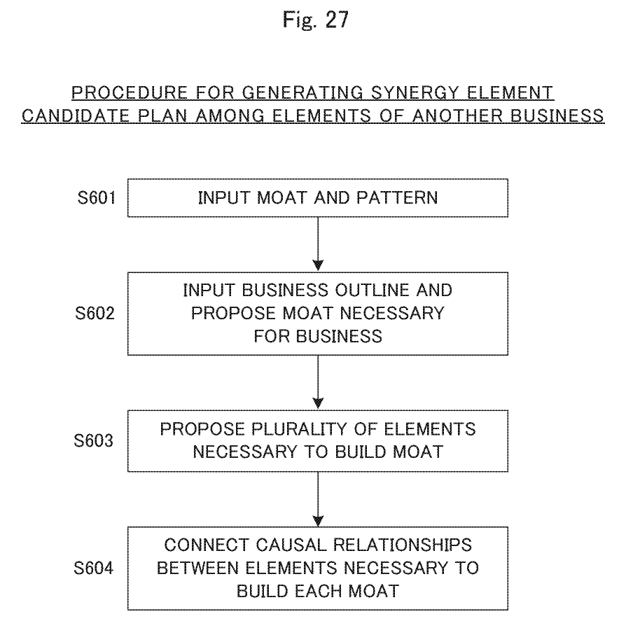

The server 1 may automatically generate a synergy element candidate by using the generative AI including the LLM. FIG. 27 is a flowchart illustrating a procedure for generating the synergy element candidate plan among elements of another business. First, the server 1 inputs a moat and various patterns as illustrated in FIG. 8 to the LLM (step S601). Specifically, the server 1 generates a prompt to input definitions and specific examples of the moat and pattern, and inputs the prompt to the LLM.

Next, the server 1 inputs a business outline and proposes a moat necessary for the business (step S602). Specifically, the server 1 inputs input information by the user, generates a prompt to propose the moat necessary for the business, and inputs the prompt to the LLM. The server 1 proposes a plurality of elements necessary to build the proposed moat (step S603). Specifically, the server 1 generates a prompt to propose the element necessary to build the proposed moat, and inputs the prompt to the LLM. The server 1 connects causal relationships between the elements necessary to build each moat (step S604). Specifically, the server 1 generates a prompt to instruct to connect the causal relationships between the proposed elements and inputs the prompt to the LLM. In this manner, the server 1 automatically generates the synergy element candidate plan by using the LLM.

### Sixth Modification Example

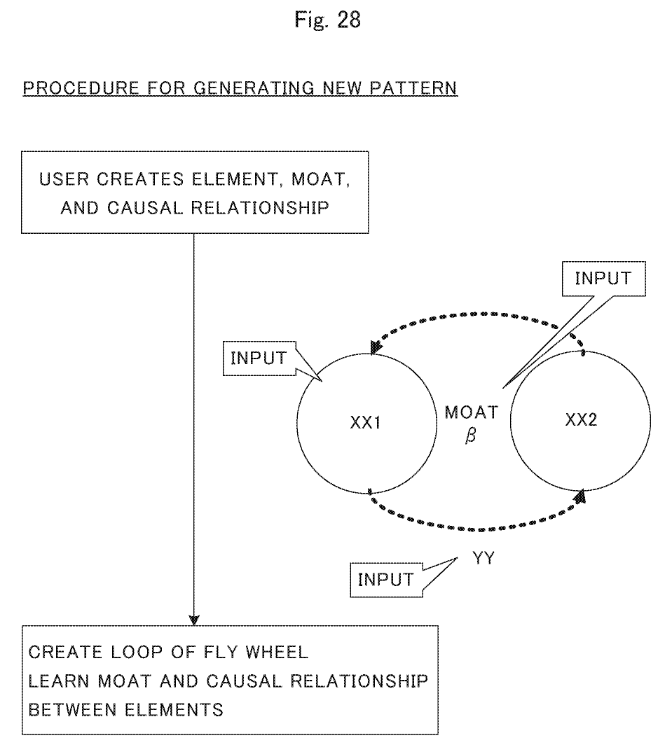

The server 1 may create a fly wheel by generating a new pattern without referring to the known pattern. FIG. 28 is a diagram for illustrating a procedure for generating the new pattern. As illustrated in FIG. 28, first, the user creates elements, a moat, and a causal relationship. The server 1 refers to the inter-element association DB 31 and creates a fly wheel based on the elements, the moat, and the causal relationship created by the user. In addition, the server 1 stores the moat of the newly created fly wheel and the causal relationship between the elements in the inter-element association DB 31.

The server 1 may create the fly wheel by using the LLM based on the inter-element association DB31 or the elements, the moat, and the causal relationship created by the user.

### Second Example Embodiment

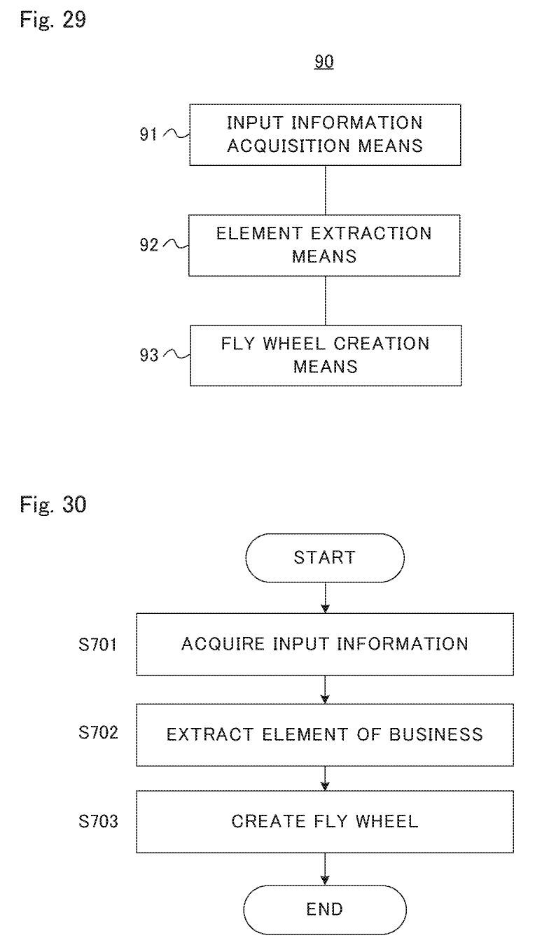

FIG. 29 is a block diagram illustrating an example of a functional configuration of a business support device in the present disclosure. A business support device 90 includes an input information acquisition means 91, an element extraction means 92, and a fly wheel creation means 93.

FIG. 30 is a flowchart illustrating an example of processing by the business support device 90. The input information acquisition means 91 acquires input information regarding a business a user is considering (step S701). The element extraction means 92 extracts an element of the business from the input information (step S702). The fly wheel creation means 93 creates a fly wheel representing the business by connecting a plurality of extracted elements through a causal relationship (step S703). According to the business support device 90, it is possible to support the business the user is considering, by accumulating and reusing assets acquired in the business.

Additionally, some or all of the above example embodiments (including modification examples, the same applies below) may also be described as follows, but are not limited to the following.

### Supplementary Note 1

A business support device comprising:

an input information acquisition means configured to acquire input information regarding a business a user is considering;

an element extraction means configured to extract an element of the business from the input information; and

a fly wheel creation means configured to create a fly wheel representing the business, by connecting a plurality of extracted elements through a causal relationship.

### Supplementary Note 2

The business support device according to Supplementary Note 1, comprising:

an inter-element relevance holding means configured to hold relevance between elements;

a determination means configured to determine, based on the element extracted from the input information and the relevance held, presence or absence of an element that can be related to the element; and

a proposal means configured to propose, to the user, the element that can be related as an element candidate.

### Supplementary Note 3

The business support device according to Supplementary Note 2, wherein

the fly wheel creation means creates a new fly wheel by connecting the element extracted from the input information and the element candidate, and

the proposal means proposes the new fly wheel to the user.

### Supplementary Note 4

The business support device according to Supplementary Note 2, wherein the proposal means proposes another business indicated by a fly wheel including the element candidate as a business having synergy with the business the user is considering.

### Supplementary Note 5

The business support device according to Supplementary Note 1, wherein the fly wheel includes one or more loops connecting a plurality of elements through a causal relationship, and has a moat that is an advantage of a business by the elements of the loops.

### Supplementary Note 6

The business support device according to Supplementary Note 5, wherein the fly wheel creation means creates the fly wheel in such a way that an element related to the moat is distinguishable from other elements in a case where the moat is selected.

### Supplementary Note 7

The business support device according to Supplementary Note 2, comprising a learned model holding the relevance between the elements, wherein

the element extraction means extracts an element of the business from the input information by using the learned model, and

the fly wheel creation means creates a fly wheel representing the business, by using the learned model.

### Supplementary Note 8

The business support device according to Supplementary Note 2, comprising a learned model holding the relevance between the elements,

wherein the determination means determines presence or absence of an element that can be related to the element extracted from the input information, by using the learned model.

### Supplementary Note 9

A business support method executed by a business support device, comprising:

acquiring input information regarding a business a user is considering;

extracting an element of the business from the input information; and

creating a fly wheel representing the business, by connecting a plurality of extracted elements through a causal relationship.

### Supplementary Note 10

A program executed by a business support device including a computer, the program causing the computer to execute processing of:

acquiring input information regarding a business a user is considering;

extracting an element of the business from the input information; and

creating a fly wheel representing the business, by connecting a plurality of extracted elements through a causal relationship.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been described with reference to embodiments, the disclosure is not limited to the example embodiments described above. Various modifications may be made to the configuration and details of a disclosure within the scope of the disclosure as understood by those skilled in the art. That is, the present disclosure naturally includes the entire disclosure, including the claims, and various modifications and alterations that would be made by those skilled in the art in light of the technical concept.

### DESCRIPTION OF SYMBOLS

1 Server

2 User terminal

11, 21 Interface

12, 22 Processor

13, 23 Memory

14, 24 Recording medium

15, 25 Display unit

16, 26 Input unit

31 Inter-element association DB

41 Input information acquisition unit

42 Element extraction unit

43 Fly wheel creation unit

44 Inter-element relevance learning unit

45 Synergy determination unit

46 Synergy proposal unit

100 Business support system

1. A business support device comprising:
at least one memory configured to store instructions; and
at least one processor configured to execute the instructions to:
acquire input information regarding a first business a user is considering;
extract an element of the first business from the input information; and
create a fly wheel representing the first business, by connecting a plurality of extracted elements through a causal relationship.

2. The business support device according to claim 1, wherein the processor is further configured to:
hold relevance between elements;
determine, based on the element extracted from the input information and the relevance held, presence or absence of an element that can be related to the element; and
propose, to the user, the element that can be related as an element candidate.

3. The business support device according to claim 2, wherein
the processor is further configured to create a new fly wheel by connecting the element extracted from the input information and the element candidate, and
the processor proposes the new fly wheel to the user.

4. The business support device according to claim 2, wherein the processor proposes a second business indicated by a fly wheel including the element candidate as a business having synergy with the first business the user is considering.

5. The business support device according to claim 1, wherein the fly wheel includes one or more loops connecting a plurality of elements through a causal relationship, and has a moat that is an advantage of a business by the elements of the loops.

6. The business support device according to claim 5, wherein the processor creates the fly wheel in such a way that an element related to the moat is distinguishable from other elements in a case where the moat is selected.

7. The business support device according to claim 2, comprising a learned model holding the relevance between the elements, wherein
the processor extracts an element of the first business from the input information by using the learned model, and
the processor creates a fly wheel representing the first business, by using the learned model.

8. The business support device according to claim 2, comprising a learned model holding the relevance between the elements,
wherein the processor determines presence or absence of an element that can be related to the element extracted from the input information, by using the learned model.

9. The business support device according to claim 1, wherein the processor is further configured to:
determine, by a machine learning model based on a relevance between elements, whether a second business having a potential synergistic effect with the business being considered by the user exists; and
propose the second business as a candidate for collaboration to support decision-making by the user.

10. A business support method executed by a business support device, comprising:
acquiring input information regarding a business a user is considering;
extracting an element of the business from the input information; and
creating a fly wheel representing the business, by connecting a plurality of extracted elements through a causal relationship.

11. A non-transitory computer-readable recording medium storing a computer, the program causing the computer to execute processing of:
acquiring input information regarding a business a user is considering;
extracting an element of the business from the input information; and
creating a fly wheel representing the business, by connecting a plurality of extracted elements through a causal relationship.
